(19) United States
(12) Patent Application Publication
(10) Pub. No.: US 2012/0249877 A1
(43) Pub. Date: Oct. 4, 2012

(54) DETERMINING VIDEO STREAM DISPLAY POSITIONING

(76) Inventors: Fabio J. Hernandez Costa, Fort Collins, CO (US); Emily Walters, Windsor, CO (US); Jeffrey Joel Walls, Fort Collins, CO (US); John Luke Herndon, Fort Collins, CO (US); Michael D. Derocher, Corvallis, OR (US)

(21) Appl. No.: 13/072,948

(22) Filed: Mar. 28, 2011

(51) Int. Cl. H04N 5/445

(52) U.S. Cl. 348/564; 348/E05.099

(57) ABSTRACT

Implementations disclosed herein relate to determining position information for displaying video streams of multiple aspect ratios. In one implementation, a processor determines position information for widows for displaying incoming video streams based on the aspect ratios of the incoming video streams. The processor may then provide the determined position information.

### BACKGROUND

A video stream may have a particular aspect ratio representing a ratio of the width to the height of the video images. A camera may capture the video stream at a particular aspect ratio. The video stream may be adjusted to a different ratio when viewed, but adjusting the size of the video stream to a different ratio than the one at which it was captured may distort the video stream.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of an electronic device.

FIG. 2 is a flow chart illustrating one example of a method to group video streams for display based on their aspect ratios.

FIG. 3-6 are block diagrams illustrating examples of video stream window arrangements on displays.

FIG. 7 is a flow chart illustrating one example of a method to determine a size of video stream windows based on their aspect ratios.

FIGS. 8A and 8B illustrate one example of updating an arrangement of video stream windows on a display.

FIGS. 9A, 9B, and 9C are diagrams illustrating examples of grouping video streams of the same aspect ratio within a grouping window.

### DETAILED DESCRIPTION

A processor may determine a position of video stream windows on a display to accommodate video streams of different aspect ratios at the same time. The video streams may each be captured by a different camera, such as where each video stream is captured at a different computer for a video conferencing system. As a result, the video streams may have different aspect ratios. The aspect ratio may indicate a ratio between a height and width. Making video stream windows have the same width and height where the video streams have different aspect ratios may result in altering the ratio of width to height for some of the video stream windows and causing those video streams to appear distorted. In one implementation, windows of video streams of the same aspect ratio may be grouped together for display, and in some implementations the video stream windows of the same aspect ratio may be altered to be the same size. For example, in a video conference involving six incoming video streams, three having a 3:2 aspect ratio and three having a 16:9 aspect ratio, the three video streams having a 3:2 aspect ratio may be arranged in a first row and the three video streams having a 16:9 aspect ratio may be arranged in a second row. Grouping video streams of the same aspect ratio may make the video streams easier to view, such as on a personal display device.

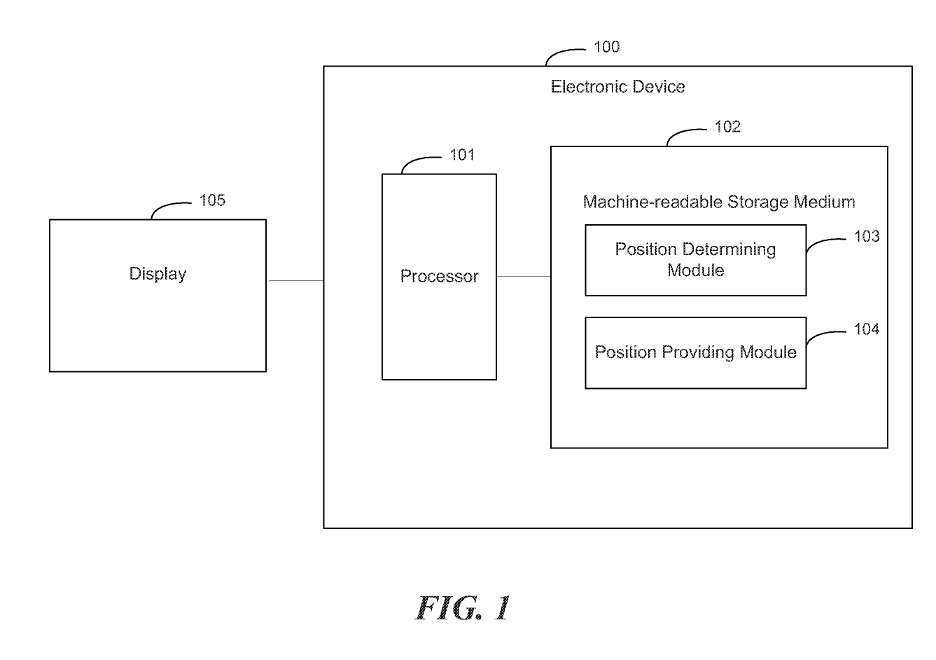

FIG. 1 is a block diagram illustrating one example of an electronic device 100. The electronic device 100 may be, for example, a personal computer, server, or mobile computing device. The electronic device 100 may include or communicate with a display 105 for displaying information to a user, such as for displaying streams of video. In some implementations, the electronic device 100 may include or communicate with a camera for capturing images. For example, the electronic device 100 may he used for video conferencing where the camera captures video of a participant using the electronic device 100, and the display 105 shows video streams associated with other participants.

The electronic device 100 may include a processor 101 and a machine-readable storage medium 102. The processor 101 may be any suitable processor, such as a central processing unit (CPU), a semiconductor-based microprocessor, or any other device suitable for retrieval and execution of instructions. In one implementation, the electronic device 100 includes logic instead of or in addition to the processor 101. As an alternative or in addition to fetching, decoding, and executing instructions, the processor 101 may include one or more integrated circuits (ICs) (e.g., an application specific integrated circuit (ASIC)) or other electronic circuits that comprise a plurality of electronic components for performing the functionality described below. In one implementation, the electronic device 100 includes multiple processors. For example, one processor may perform some functionality and another processor may perform other functionality.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101. The machine-readable storage medium 102 may include a position determining module 103 to determine the position of video streams based on their aspect ratios and position providing module 104 to provide the determined position information (e.g., to a display device communicatively coupled to or otherwise associated with electronic device 100). The position determining module 103 and the position providing module 104 may include instructions executable by the processor 101.

The position determining module 103 may include instructions to determine an arrangement for positioning windows for received incoming video streams on a display at the same time where the video streams have different aspect ratios. Windows of video streams with the same aspect ratios may be grouped together, such as displayed next to one another without a video stream of a different aspect ratio between the video streams of the same aspect ratio. For example, windows of video streams of a first aspect ratio may be grouped together for display in a first row and windows of video streams of a second aspect ratio may he grouped together for display in a second row. In some cases, the windows with video streams of the same aspect ratio may be altered to have the same size.

The position providing module 104 may include instructions to provide the determined position information. For example, the position information may be sent to the display 105 or to another electronic device for displaying the video streams. In some implementations, the position information may be stored or transmitted via a network.

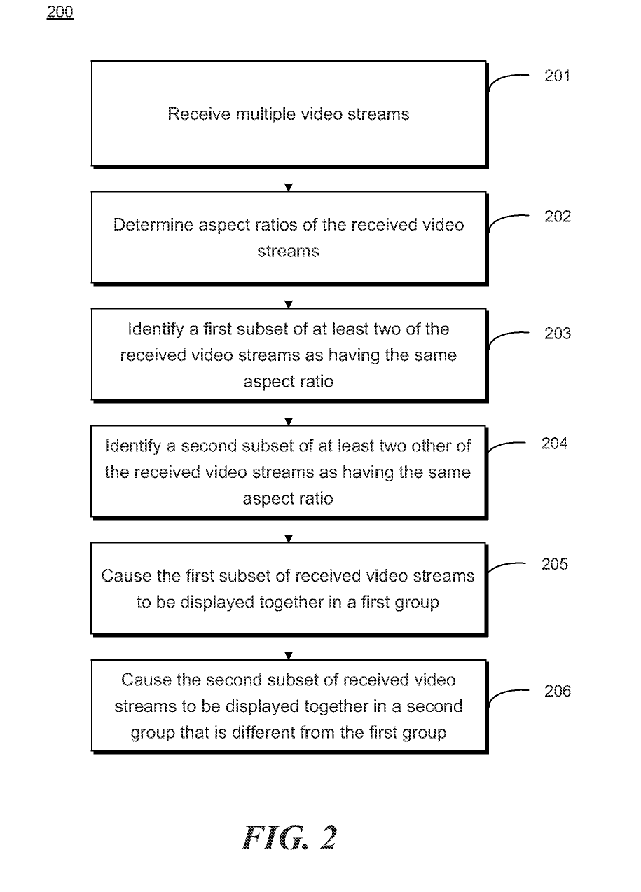

FIG. 2 is a flow chart 200 illustrating one example of a method to group video streams for display. For example, a processor may group video streams of the same aspect ratio together for display. A first subset may be created of video streams of a first aspect ratio and a second subset may be created of video streams of a second aspect ratio. The processor may cause the video streams to be displayed according to the grouping. For example, information about the video stream positions may be sent to a display device. The method may be executed, for example, by the electronic device 100.

Beginning at 201, a processor, such as the processor 101 receives multiple video streams. For example, each video stream may be associated with a participant or a participant location for a video conference. The video streams may be received from multiple sources such that they may have different aspect ratios. The processor may receive the video streams in any suitable manner. For example, the video streams may originate or be received via a network or may be retrieved from a storage medium.

Moving to 202, the processor determines aspect ratios of the received video streams. The processor may determine the aspect ratios, for example, based on information received with the video streams or based on an analysis of the video streams. The aspect ratios may indicate a ratio of width to height of a video stream image (e.g., a ratio of the number of columns of pixels to the number of rows of pixels in a digital image). Different camera configurations may capture images with different aspect ratios, and an image captured with a particular aspect ratio in some cases may appear distorted when the aspect ratio is not preserved. For example, altering the aspect ratio may make the image appear to be distorted. The aspect ratios may be, for example, a width to height ratio of 4:3 or 16:9.

Continuing to 203, the processor identifies a first subset of at least two of the received video streams as having the same aspect ratio. For example, if three video streams are received with aspect ratios 4:3 and four video streams are received with aspect ratios 16:9, the processor may identify a first subset as the three video streams with aspect ratios 4:3. The processor may create multiple groups for video streams of the same aspect ratio or a single group for video streams of the same aspect ratio.

Proceeding to 204, the processor identifies a second subset of at least two other of the received video streams as having the same aspect ratio. For example, a second subset may be identified with two or more video streams with aspect ratios 16:9. The processor may identify additional subsets. For example, the processor may receive video streams with three or four different aspect ratios.

Continuing to 205, the processor causes the first subset of received video streams to be displayed together in a first group. For example, the processor may cause the received video streams to be displayed in particular manner by sending information about the position of the video streams to a display device for displaying the video streams. The processor may cause the first subset of video streams to be displayed in any suitable manner, such as in the same row or column on the display or next to one another. The video streams of the first subset may be caused to be displayed adjacent to one another such that there are not video streams of different aspect ratios between the video streams of the first subset.

In one implementation, causing a subset of video streams to be displayed together involves displaying video stream windows together within a larger window encompassing the individual video stream windows. The behavior of the individual video stream windows may be changed based on manipulations to the larger window. For example, the larger window may be moved and resized such that the individual video stream windows are moved and resized with the larger window.

Moving to 206, the processor causes the second subset of received video streams to he displayed together in a second group that is different from the first group. For example, the first subset may be displayed in a first row and the second subset may be displayed in a second row. As another example, a single row may contain the video streams from the first subset next to one another and then the video streams from the second subset next to one another. In one implementation, the processor also sizes the video streams of each subset to be the same. For example, the video streams of the first subset may each be a first size and the video streams of the second subset may each be a second size.

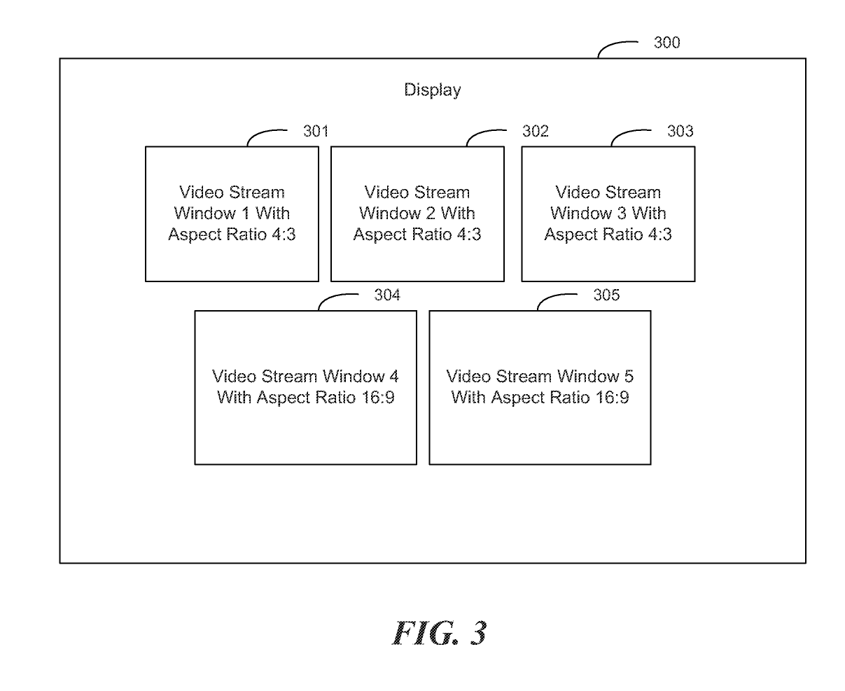

FIGS. 3-6 are block diagrams illustrating examples of video stream window arrangements on displays. The displays may be any suitable display devices, such as monitors, projection screens, or mobile computing device screens. The video stream windows may be windows displayed on the displays that each show a video stream. For example, each video stream may originate or be received from a different source, such as from a different participant location in a video conferencing scenario. The video stream windows may be arranged such that video stream windows with the same aspect ratios are grouped together.

FIG. 3 is a block diagram illustrating one example of a video stream window arrangement on a display 300. The video stream windows 301, 302, 303. 304, and 305 are displayed such that video stream windows with the same aspect ratios are grouped together. The video stream windows 301, 302, and 303 with aspect ratios 4:3 are displayed in a group in a first row, and the video stream windows 304 and 305 with aspect ratios 16:9 are displayed in a group in a second row.

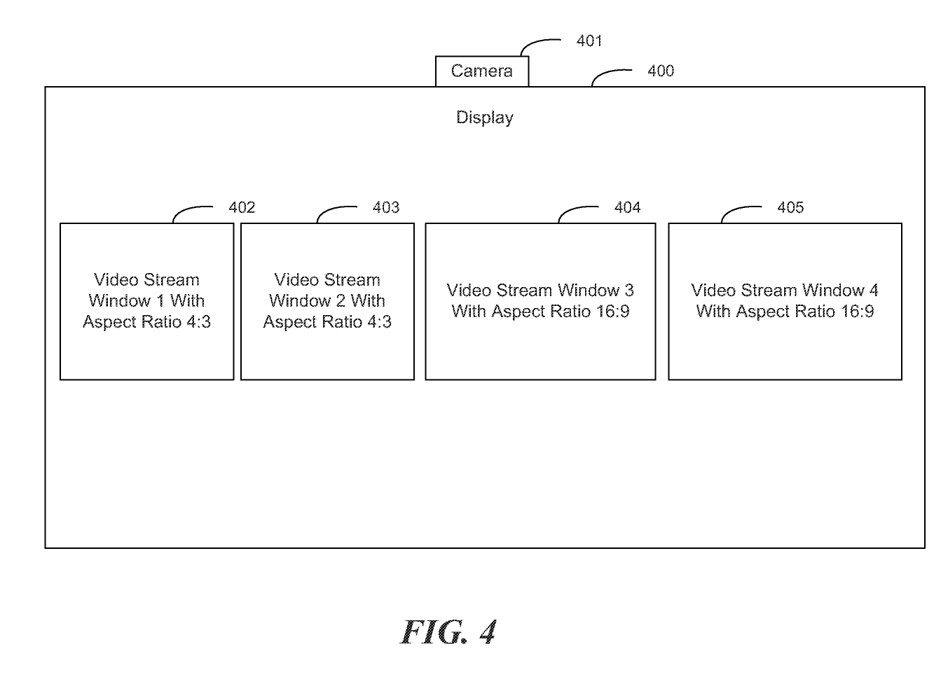

FIG. 4 is a block diagram illustrating one example of a video stream window arrangement on a display 400. The display 400 may have an associated camera 401. The camera 401 may be used to capture a video stream of a participant using the display 400. The video stream windows 402, 403, 404, and 405 may be displayed in a row near the camera 401 such that a person viewing the video stream windows 402, 403, 404, and 405 would also be looking near the camera 401. For example, the video stream windows 402, 403, 404, and 405 may include video streams of participants for a video conference, and a participant viewing the video streams 402, 403, 404, and 405 may appear to be looking into the camera 401 for creating a video stream of that participant.

In some implementations, one dimension of video stream windows of different aspect ratios may be the same size and the other dimension of the video stream windows may he determined based on their aspect ratio. For example, video stream windows of 4:3 video streams and 16:9 video streams may be sized to have the same height, and the width may then be determined based on the aspect ratios. A processor may size video stream windows such that windows with different aspect ratios have either the same height or width with the other dimension determined by the aspect ratio. For example, for images 1 and 2 with aspect ratio 4:3 and images 3 and 4 with aspect ratio 16:9, each of images 1 2, 3, and 4 may be adjusted to have a width of 4 cm. The height of the images 1 and 2 with aspect ratio 4:3 may then be 3 cm, and the height of the images 3 and 4 with aspect ratio 16:9 may then be 2.25 cm. The video stream windows 402, 403, 404, and 405 of FIG. 4 are sized such that they each have the same height. The video stream windows 404 and 405 are wider than the video stream windows 402 and 403 because of their 16:9 aspect ratio. Making the video stream windows 402, 403, 404, and 405 the same height may help align the eye height of people shown in the video stream windows 402, 403, 404, and 405 in a video conferencing scenario.

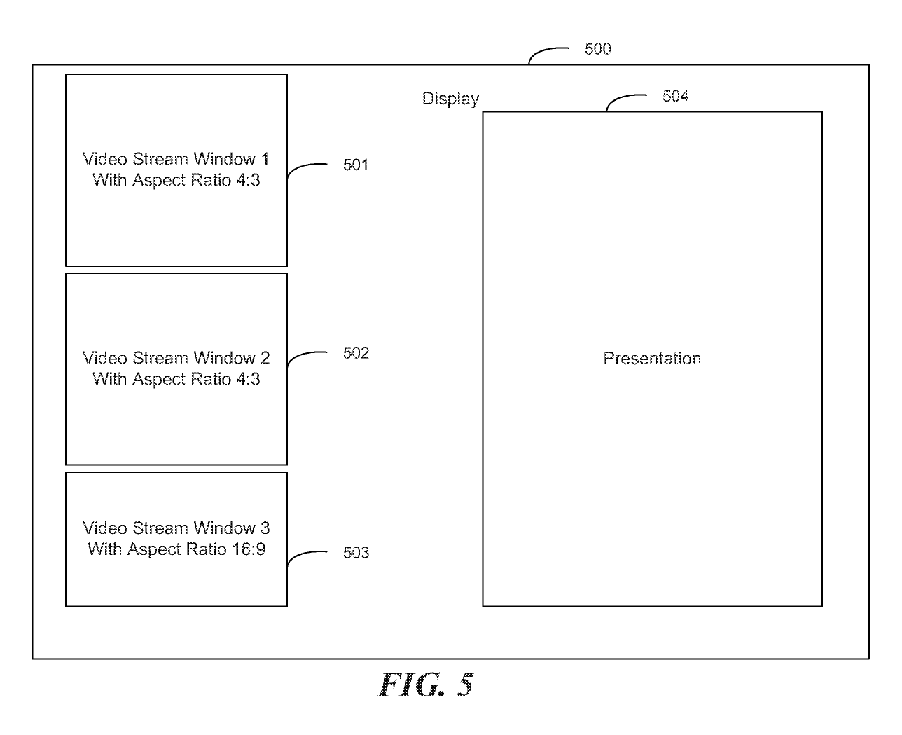

FIG. 5 is a block diagram illustrating one example of a video stream window arrangement on a display 500. The display 500 also displays a presentation 504. The presentation 504 may be, for example, a slide deck, presentation or other document. The presentation 504 may be shared between a video conference participant using the display 500 and video conference participants shown in the video stream windows 501, 502, and 503. For example, one or more of the participants may control the presentation 504. The display 500 may be arranged in any suitable manner. For example, the presentation 504 may he positioned to the left or right of the video stream windows 501, 502, and 503. The size and position of a presentation may be taken into account when positioning the video stream windows so that they do not overlap. In some implementations, other items shown on the display are not taken into account, and the video stream windows may overlap them. The video stream windows 501, 502, and 503 may be grouped based on the aspect ratio in a column along the display 500. For example, video stream windows 501 and 502 with aspect ratios 4:3 are next to one another, with video stream window 503 with aspect ratio 16:9 being displayed beneath the video stream windows 501 and 502. If another video stream window with aspect ratio 16:9 (not shown) were to be displayed, it may be grouped with the video stream window 503 for display (e.g., displayed beneath the video stream window 503).

The video stream windows 501, 502, and 503 are sized such that each video stream window has the same width, and the height is then determined based on the aspect ratio. For example, video stream windows 501 and 502 with aspect ratio 4:3 are taller than the video stream window 503 with aspect ratio 16:9. In some implementations, video stream windows of different aspect ratios are not the same size and a border may be placed around smaller video stream windows such that the video stream windows of different aspect ratios are the same size with the border. For example, a frame could be placed around the video stream window 503 to make it the same size as the video stream windows 501 and 502.

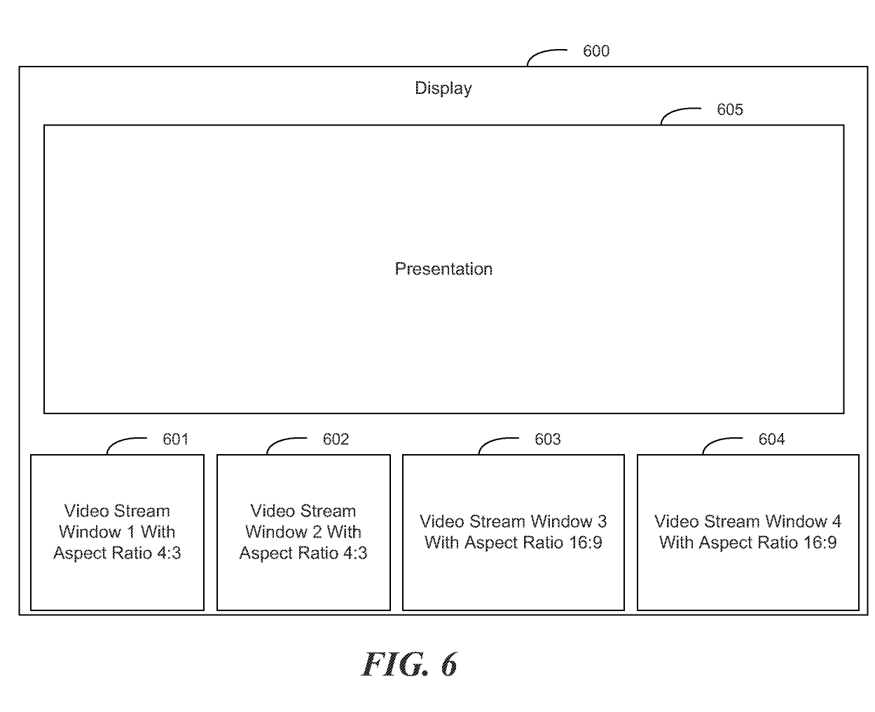

FIG. 6 is a block diagram illustrating one example of a video stream window arrangement on a display 600. A presentation 605 is shown with video stream windows 601, 602, 603, and 604 placed below the presentation 605. The video stream windows 601 and 602 with aspect ratio 4:3 are grouped together, and the video stream windows 603 and 604 with aspect ratio 16:9 are grouped together. The video stream windows 601, 602, 603 and 604 are sized to have the same height, which results in the video stream windows 603 and 604 having a larger width than the video stream windows 601 and 602.

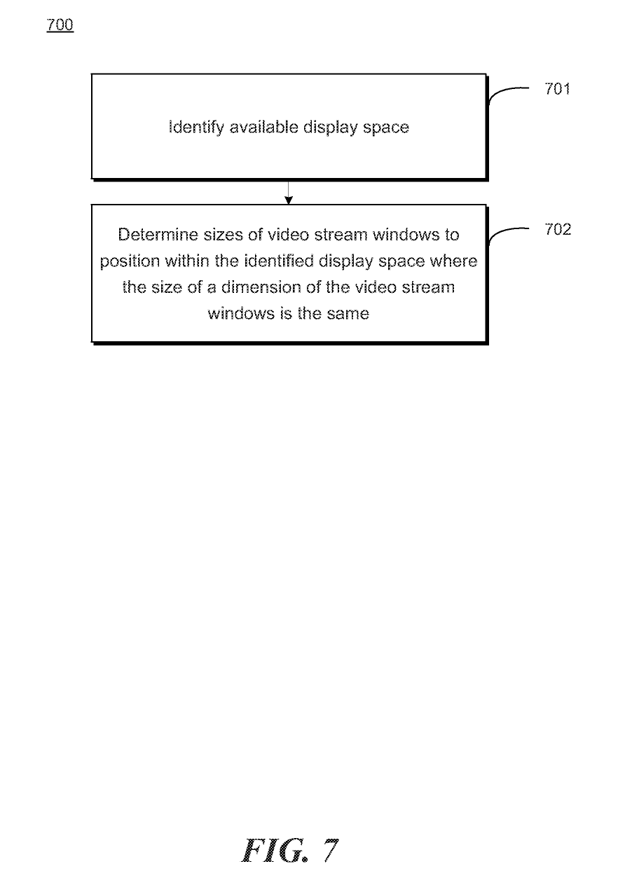

FIG. 7 is a flow chart 700 illustrating one example of a method to determine a size for video stream windows based on their aspect ratios. The processor may determine a size of the video stream windows based on the available display space on a display device. For example, the processor may maximize one dimension of the video stream windows to fill the available display space and adjust the other dimension based on the aspect ratio. The method may be performed, for example, by the processor 101 of FIG. 1.

Beginning at 701, the processor identifies available display space. For example, the processor may identify available display space based on the size of a display screen. The processor may determine the dimensions of the identified available display space. In some cases, the amount of available display space may be determined based on other objects shown on the display screen. For example, there may be other icons displayed or other program windows open. In some implementations, the amount of available display space is calculated as a percentage of free space on the display, such as where 70 percent of the width of the display screen or 80 percent of the height of the display screen may be used for displaying video stream windows. In some cases, the processor may determine that the available display space is not contiguous.

Continuing to 702, the processor determines sizes of video stream windows to position within the identified display space where the size of a dimension of the video stream windows is the same. For example, the processor may size the video stream windows such that the width of the video stream windows is maximized within the identified display space where the height of the video stream windows is the same or where the width of the video stream windows is the same. As another example, the processor may size the video stream windows such that the height of the video stream windows is maximized within the identified display space where the height of the video stream windows is the same or the width of the video stream windows is the same. In some implementations, the processor maximizes both the height and the width of the video stream windows within the identified display space such that the area used by the video stream windows is maximized.

In some implementations, the processor may maximize the size of a portion of the video stream windows within the identified display space, such as the video stream windows in a particular row, column, or area of the identified display space. The processor may determine a number of video stream windows to place within a row, column, or area based on user input. The processor may determine the number of video stream windows to place within a row based on the total number of video streams and a minimum allowed size for the video stream windows. In some implementations, once the video stream windows are automatically sized and positioned, the user may alter the size and position of the video stream windows if desired.

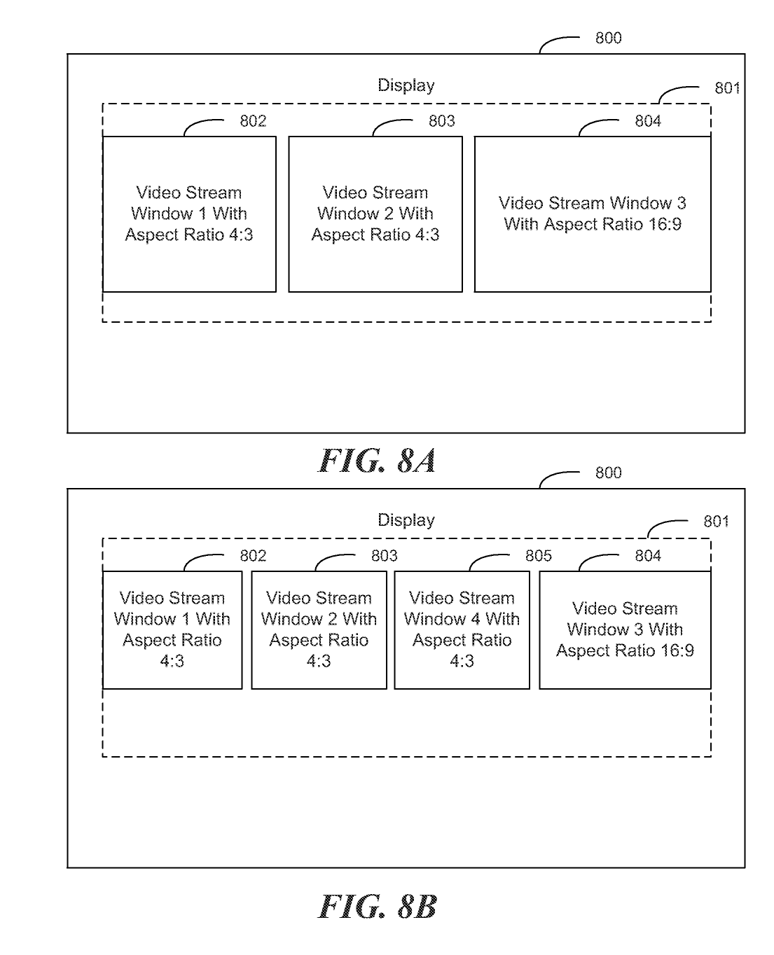

FIGS. 8A and 8B illustrate one example of updating an arrangement of video stream windows on a display 800. For example, a processor may determine a manner to group and arrange video stream windows based on the available display space and the number of video stream windows. A setting may indicate a number of video stream windows to be in particular position. For example, the setting may be for the video stream windows to be displayed in the same row. The processor may maximize the size of the video streams within the row where one dimension of the video stream windows is the same. For example, video stream windows 802, 803, and 804 are displayed on the display 800 in the same row such that video stream windows 802 and 803 with the same aspect ratio are grouped together. The video stream windows 802, 803, and 804 are sized such that the width of the video stream windows 802, 803, and 804 is maximized within a display space 801 where the video stream windows 802, 803, and 804 have the same height. The width is then determined based on the aspect ratio.

In FIG. 8B, a fourth video stream window 805 is added with aspect ratio 4:3. For example, another participant may be added to a video conference. The video stream window 805 is grouped with the video stream windows 802 and 803 of the same aspect ratio. The video stream windows 802, 803, 804, and 805 are sized such that the width of the video stream windows 802, 803, 804, and 805 is maximized within the display space 801 and the height of the video stream windows 802, 803, 804, and 805 is the same. The video stream windows 802, 803, 804, and 805 are slimmer than in FIG. 8A because of the extra video stream window 805 added. The height is decreased to maintain the aspect ratios with the smaller width.

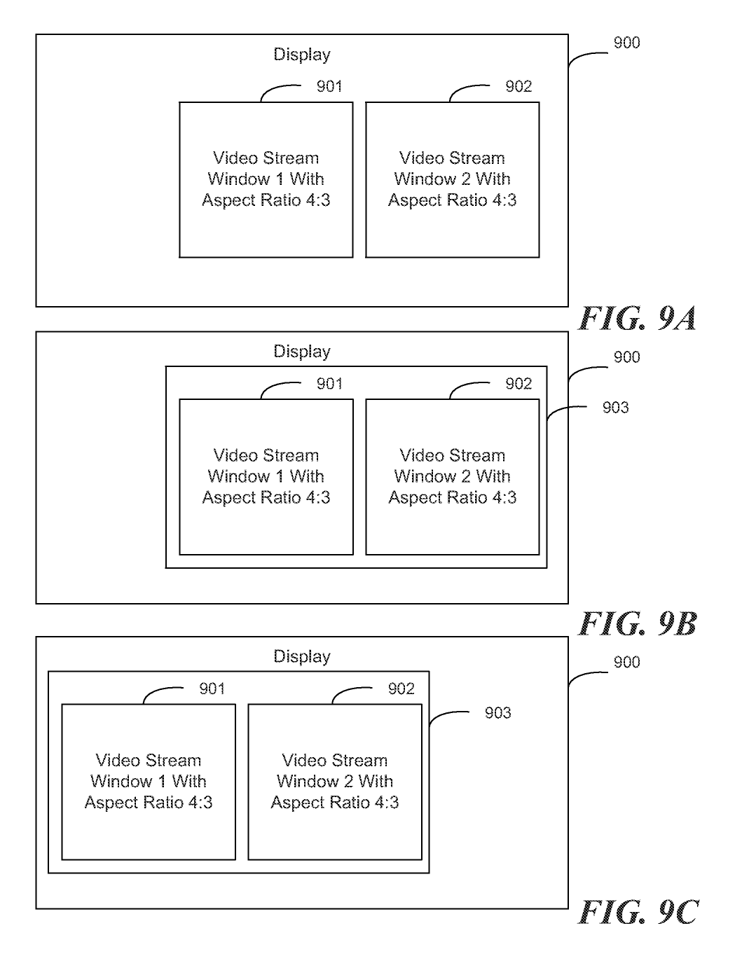

FIGS. 9A, 98, and 9C are diagrams illustrating examples of grouping video streams of the same aspect ratio within a grouping window. Video streams of the same aspect ratio may be grouped within a grouping window such that the video stream windows are altered based on changes to the grouping window. For example, the size of the video stream windows may be altered based on a change to the grouping window. As another example, the position on the display may be changed by moving the grouping window, and the relative position of the video stream windows may be maintained within the grouping window. The grouping window may automatically encompass video streams of the same aspect ratio, or a user may select video streams of the same aspect ratio to include within a grouping window. In some implementations, video stream windows of the same aspect ratio may be automatically grouped together when they are placed within a particular distance of one another.

FIG. 9A shows a display 900 with video stream windows 901 and 902 of aspect ratio 4:3. FIG. 9B shows the video stream windows 901 and 902 grouped together within a grouping window 903. The grouping window 903 may be visible or invisible to a user. FIG. 9C shows the video stream windows 901 and 902 moved on the display 901 such that they are moved together within the grouping window 903 where the grouping window 903 is moved across the display.

Grouping video streams for display based on aspect ratios may create a more aesthetically pleasing display and allow a user to more easily view multiple video streams simultaneously. For example, grouping video streams by aspect ratio may be useful for a video conferencing system.

1. A method comprising:
receiving multiple video streams;
determining aspect ratios of the received video streams;
based on the determined aspect ratios of the received video streams,
identifying a first subset of at least two of the received video streams as having the same aspect ratio, and
identifying a second subset of at least two other of the received video streams as having the same aspect ratio, the determined aspect ratio of the received video streams of the second subset being different from the determined aspect ratio of the received video streams of the first subset;
as a consequence of having identified the first subset of received video streams as having the same aspect ratio, causing the first subset of received video streams to be displayed together in a first group; and
as a consequence of having identified the second subset of received video streams as having the same aspect ratio, causing the second subset of received video streams to be displayed together in a second group that is different from the first group.

2. The method of claim 2, wherein:
receiving multiple video streams includes receiving four video streams;
determining aspect ratios of the received video streams includes:
determining that a first video stream of the received video streams has a 4:3 aspect ratio,
determining that a second video stream of the received video streams has a 4:3 aspect ratio,
determining that a third video stream of the received video streams has a 16:9 aspect ratio, and
determining that a fourth video stream of the received video streams has a 16:9 aspect ratio;
identifying a first subset of at least two of the received video streams as having the same aspect ratio includes identifying the first and second video streams as both having a 4:3 aspect ratio;
identifying a second subset of at least two other of the received video streams as having the same aspect ratio includes identifying the third and fourth video streams as both having a 16:9 aspect ratio;
causing the first subset of received video streams to be displayed together in a first group as a consequence of having identified the first subset of received video streams as having the same aspect ratio includes causing the first and second video streams to be displayed together in a first group; and
causing the second subset of received video streams to be displayed together in a second group as a consequence of having identified the second subset of received video streams as having the same aspect ratio includes causing the third and fourth video streams to be displayed together in a second group.

3. The method of claim 1, wherein:
receiving multiple video streams includes receiving four video streams;
identifying a first subset of at least two of the received video streams as having the same aspect ratio includes identifying a first video stream and a second video stream as having the same aspect ratio;
identifying a second subset of at least two of the received video streams as having the same aspect ratio includes identifying a third video stream and a fourth video stream as having the same aspect ratio;
causing the first subset of received video streams to be displayed together in a first group as a consequence of having identified the first subset of received video streams as having the same aspect ratio includes causing the first and second video streams to be displayed in a first row on a display device; and
causing the second subset of received video streams to be displayed together in a second group as a consequence of having identified the second subset of received video streams as having the same aspect ratio includes causing the third and fourth video streams to be displayed in a second row on the display device, the second row being different from the first row.

4. The method of claim 1, wherein:
receiving multiple video streams includes receiving four video streams;
identifying a first subset of at least two of the received video streams as having the same aspect ratio includes identifying a first video stream and a second video stream as having the same aspect ratio;
identifying a second subset of at least two of the received video streams as having the same aspect ratio includes identifying a third video stream and a fourth video stream as having the same aspect ratio;
causing the first subset of received video streams to be displayed together in a first group as a consequence of having identified the first subset of received video streams as having the same aspect ratio includes causing the first video stream to be displayed adjacent to the second video stream in a row on a display device; and
causing the second subset of received video streams to be displayed together in a second group as a consequence of having identified the second subset of received video streams as having the same aspect ratio includes causing the third video stream to be displayed adjacent to the fourth video stream in the row on the display device.

5. An apparatus comprising:
a processor to:
determine position information for multiple widows for displaying video streams on a display device based on aspect ratios of the video streams; and
provide the determined position information to the display device.

6. The apparatus of claim 5, wherein determining position information comprises:
determining to position a first subset of at least two video streams having the same aspect ratio in a first group;
determining to position a second subset of at least two video streams having the same aspect ratio in a second group that is different than the first group;
causing the video streams in the first group to be displayed together; and
causing the video streams in the second group to be displayed together.

7. The apparatus of claim 5, wherein determining position information comprises determining to position a window adjacent to other windows with video conferencing streams of the same aspect ratio.

8. The apparatus of claim 5, wherein determining to position comprises determining to position the windows in rows where a row includes windows with video conferencing streams of the same aspect ratio.

9. The apparatus of claim 5, wherein the processor further adjusts the size of the widows based on the aspect ratio of the video streams.

10. A method for positioning video conferencing windows, comprising:
determining, by a processor, a position for multiple video conferencing windows within a display area on a display device, wherein the video conferencing windows display video streams with different aspect ratios; and
providing, by the processor, information related to the determined position.

11. The method of claim 10, wherein determining the position comprise determining to position two video conferencing windows with video streams of a first aspect ratio in one row and determining to position a video conferencing window with a video stream of a second aspect ratio in another row.

12. The method of claim 10, further comprising updating the determined position of the video conferencing windows where there is a change in the number of video conferencing windows.

13. The method of claim 10, wherein determining the position of video conferencing windows comprises determining to position at least two video conferencing windows with video streams of the same aspect ratio next to one another.

14. The method of claim 10, further comprising adjusting the size of the video conferencing windows based on the aspect ratios of the video streams.

15. A machine readable non-transitory storage medium including instructions executable by a processor, comprising instructions to:
determine an arrangement of multiple windows receiving incoming video streams based on the aspect ratio of the video streams; and
provide information about the determined arrangement information.

16. The machine-readable non-transitory storage medium of claim 15, wherein instructions to determine the arrangement of windows comprises instructions to determine to arrange two windows receiving incoming video streams of a first aspect ratio in a first row and a window receiving an incoming video stream of a second aspect ratio in a second row.

17. The machine-readable non-transitory storage medium of claim 15, further comprising instructions to:
identify available display space; and
determine sizes of the windows to position within the identified display space where the size of a dimension of the windows is the same.

18. The machine-readable non-transitory storage medium of claim 15, wherein instructions to determine the arrangement of the windows comprise instructions to determine the arrangement of the windows further based on the size of a display area on a display device for displaying the windows.

19. The machine-readable non-transitory storage medium of claim 15, wherein instructions to determine the arrangement of the windows comprises instructions to determine to arrange windows receiving incoming video streams of the same aspect ratio adjacent to one another.

20. The machine-readable non-transitory storage medium of claim 15, wherein instructions to determine the arrangement of windows comprises instructions to:
determine to arrange a first subset of at least two video streams having the same aspect ratio in a first group;
determine to arrange a second subset of at least two video streams having the same aspect ratio in a second group that is different than the first group;
cause the video streams in the first group to be displayed together; and
cause the video streams in the second group to be displayed together.
